(19) United States
(12) Patent Application Publication
(10) Pub. No.: US 2015/0358591 A1
(43) Pub. Date: Dec. 10, 2015

(54) SECURITY METHOD USING IMAGE FRAME, DEVICE FOR EXECUTING THE METHOD, AND RECORDING MEDIUM THAT STORES THE METHOD

(71) Applicant: Jae Wan KIM, Seoul (KR)

(72) Inventor: Jae Wan KIM, Seoul (KR)

(21) Appl. No.: 14/718,414

(22) Filed: May 21, 2015

(30) Foreign Application Priority Data
Jun. 4, 2014 (KR) 10-2014-0068021

(51) Int. Cl. H04N 7/18; H04N 5/232; G06F 17/30; H04N 5/44

(52) U.S. Cl. CPC H04N 7/185; H04N 5/44; H04N 5/23245; G06F 17/30858

(57) ABSTRACT

A security method using an image frame executed in a terminal device connected to an image photographing device includes step of receiving an image frame generated according to a preset frame generation condition from the image photographing device, step of determining whether an event occurrence condition is satisfied, and step of recording and storing the image frame by adjusting the number of frames recorded per unit time according to the determination result. Therefore, by recording and storing an image frame that adjusts the number of frames recorded per unit time at an internal memory or by storing an image frame that adjusts the number of frames recorded per unit time at a cloud server by determining a situation of an image frame received from an image photographing device, even if a smart phone is robbed by a crime participant, a crime situation can be determined.

### FIELD OF INVENTION

Exemplary embodiments of the present invention relate to a security method using an image frame, a device for executing the method, and a recording medium that stores the method.

### DESCRIPTION OF THE RELATED ART

Conventionally, as preparation of a crime such as unpredictably occurring kidnapping, there was technology that depends on several closed-circuit television (CCTV) cameras for crime prevention installed at a specific region or that tracks a user location through a Global Positioning System (GPS) of a mobile phone in which a user carries.

With such conventional technology, it is difficult to track a crime participant that previously grasps and approaches a region in which the CCTV cameras for crime prevention are installed, it is not easy to accurately grasp and secure an appearance of a crime participant in view of a characteristic of CCTV cameras installed at a far distance, and the CCTV cameras may record a sound, but have a limitation in which noise is mixed and in which a voice of a victim is not accurately recorded.

Further, when a crime participant robs a mobile phone of a victim and turns off power thereof, it is difficult to track a user location through a GPS of the mobile phone, and even if a mobile phone itself records a crime situation, when the crime participant robs the mobile phone of the victim, it is difficult to secure a record file.

Due to the above problems, there is a problem that a peripheral situation of the victim is not accurately stored and that does not store a record in which the victim left with a voice such as a damage situation immediately before damage.

### PRIOR ART DOCUMENT

### Patent Document

(Patent Document 0001) Korean Patent Laid-Open Publication No. 10-2004-0084517 (Laid-open at Oct. 6, 2004)

### SUMMARY OF INVENTION

### Problem to be Solved by the Invention

The present invention has been made in an effort to provide a security method using an image frame, a device for executing the method, and a recording medium that stores the method that reduce consumption of a resource such as power or a storage space in an unimportant time zone and that enable to highly use a resource only in an important time zone by recording and storing an image frame received from an image photographing device by adjusting the number of frames recorded per unit time according to an event occurrence condition.

The present invention has been made in an effort to further provide a security method using an image frame, a device for executing the method, and a recording medium that stores the method that enable to use information stored at a cloud server, even if a smart phone is robbed by a crime participant by storing an image frame received from an image photographing device at a cloud server through a communication network according to a preset frame transmitting condition.

The present invention has been made in an effort to further provide a security method using an image frame, a device for executing the method, and a recording medium that stores the method that enable to easily acquire information about a peripheral situation of a user by enabling a crime participant not to think that an image photographing device is a camera by producing the image photographing device in a brooch or accessory form.

The present invention has been made in an effort to further provide a security method using an image frame, a device for executing the method, and a recording medium that stores the method that stores the method that uses information about a user peripheral situation stored at a cloud server when investigating a criminal event, that tracks a crime situation by simultaneously securing a user situation statement to enable to enhance a crime arrest rate.

The object of the present invention is not limited to the above-described objects and the other objects will be understood by those skilled in the art from the following description.

### Means for Solving Problems

In exemplary embodiments, a security method using an image frame executed in a terminal device connected to an image photographing device includes step of receiving an image frame generated according to a preset frame generation condition from the image photographing device, step of determining whether an event occurrence condition is satisfied, and step of recording and storing the image frame by adjusting the number of frames recorded per unit time according to a determination result.

In exemplary embodiments, a terminal device connected to an image photographing device includes a transmitting and receiving unit that receives an image frame generated according to a preset frame generation condition from the image photographing device, an image frame storage unit that stores the image frame, and a controller that determines whether an event occurrence condition is satisfied and that adjusts the number of frames recorded per unit time according to a determination result and that controls to record the image frame according to the number of frames recorded per unit time and to store the image frame at the image frame storage unit.

In exemplary embodiments, a security system using an image frame includes an image photographing device that generates and provides an image frame according to a preset frame generation condition and a terminal device that determines whether an event occurrence condition is satisfied and that adjusts the number of frames recorded per unit time according to a determination result to record and store the image frame according to the adjusted number of frames recorded per unit time.

In exemplary embodiments, a recording medium that stores a program for executing a security method using an image frame executed in a terminal device connected to an image photographing device includes a function of receiving an image frame generated according to a preset frame generation condition from the image photographing device, a function of determining whether an event occurrence condition is satisfied, and a function of recording and storing the image frame by adjusting the number of frames recorded per unit time according to a determination result.

The detailed matters of other embodiments will be included in the detailed description and the accompanying drawings.

These and other objects of the present invention and a method of attaining the objects will become more readily apparent from the detailed description given hereinafter together with the accompanying drawings. However, it should be understood that the detailed description and specific examples while indicating preferred embodiments of the invention are given by way of illustration only since various changes and modifications within the spirit and scope of the invention will become apparent to those skilled in the art from this detailed description. Like reference numerals designate like elements throughout the specification.

### (Advantages)

According to the present invention, by adjusting the number of frames recorded per unit time according to an event occurrence condition and by recording and storing an image frame received from an image photographing device, consumption of a resource such as power or storage space is possibly reduced in an unimportant time zone and a resource can be highly used only in an important time zone.

Further, according to the present invention, by storing an image frame received from an image photographing device at a cloud server through a communication network according to a preset frame transmitting condition, even if a smart phone is robbed by a criminal participant, information stored at a cloud server can be used.

Further, according to the present invention, by enabling a crime participant not to think that an image photographing device is a camera by producing the image photographing device in a brooch or accessory form, information about a user peripheral situation can be easily acquired.

Further, according to the present invention, when investigating a criminal event, by using information about a user peripheral situation stored at a cloud server, by simultaneously securing a user situation statement, and by tracking a crime situation, a crime arrest rate can be enhanced.

### BRIEF DESCRIPTION OF THE DRAWINGS

FIG. 1 is a diagram illustrating a network configuration of a security system using an image frame according to an exemplary embodiment of the present invention.

FIG. 2 is a block diagram illustrating an internal configuration of a terminal device according to an exemplary embodiment of the present invention.

FIG. 3 is a block diagram illustrating an internal configuration of an image photographing device according to an exemplary embodiment of the present invention.

FIG. 4 is a block diagram illustrating an internal configuration of an image photographing device according to another exemplary embodiment of the present invention.

FIG. 5 is a flowchart illustrating a security method using an image frame according to an exemplary embodiment of the present invention.

### DETAILED DESCRIPTION OF EXEMPLARY EMBODIMENTS

Hereinafter, exemplary embodiments of the present invention will be described in detail with reference to the accompanying drawings.

In the following description, an ‘event’ may be understood as a situation in which an attention is required due to a high security risk level or an emergency situation in which danger has already occurred and may include various kinds of events in which a user previously sets. A definition of an event and various reference values that determine whether an event has occurred may be set and stored by a user through a terminal device.

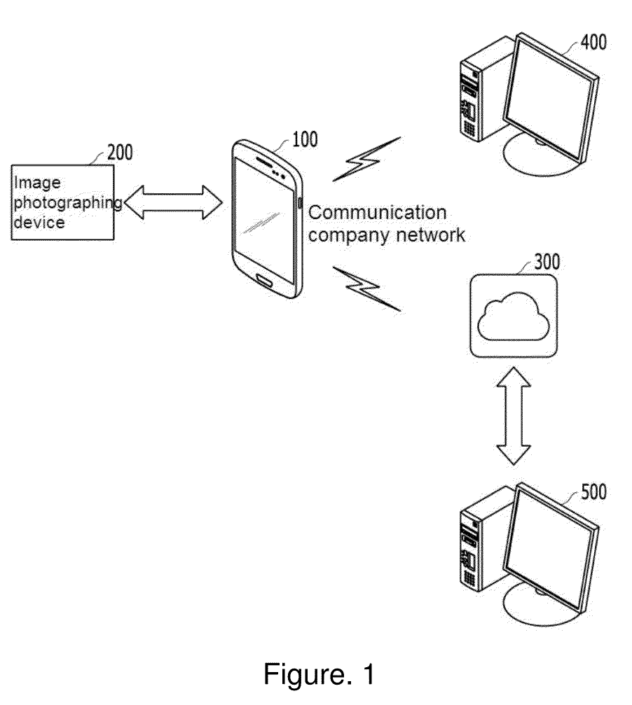

FIG. 1 is a diagram illustrating a network configuration of a security system using an image frame according to an exemplary embodiment of the present invention.

Referring to FIG. 1, the security system using an image frame includes a terminal device 100, an image photographing device 200, a cloud server 300, an emergency center terminal 400, and an information viewing terminal 500. The cloud server 300 is a cloud server of a common meaning, but does not exclude a general security management exclusive server that can interlock with the terminal device 100.

Here, the image photographing device 200 and the terminal device 100 may be connected to wire communication (e.g., Universal Serial Bus (USB) or wireless communication (e.g., Bluetooth).

The image photographing device 200 is a device that generate an image frame on a user situation and that provides the generated image frame to the terminal device 100 and may be mounted and located in a state similar to that of a black box in a user vehicle and may be mounted in a small brooch or accessory form in a thing in which the user uses. When the image photographing device 200 is mounted in the vehicle, in order to detect a vehicle unique event such as vehicle collision, the terminal device 100 may be interlocked by wire or wireless with various vehicle controllers or a sensor (e.g., a vehicle collision detection sensor (not shown), an Electronic Control Unit (ECU) (not shown)) separately installed in the vehicle.

In an exemplary embodiment, the image photographing device 200 generates an image frame according to a preset frame generation condition and provides the generated image frame to the terminal device 100. Here, a preset frame generation condition indicates the number of image frames generated per unit time in the image photographing device 200 and is connected to a PC or an application installed in the terminal device 100 to be changed. For example, when applying a known commercial camera module product to the image photographing device 200 of the present exemplary embodiment, a frame generate condition may be set with 25/30 image frames (PAL/NTSC) per second or 50/60 (PAL/NTSC) image frames per second.

When the image photographing device 200 receives a user voice signal, the image photographing device 200 converts the voice signal to a digital signal and provides the digital signal to the terminal device 100. In this case, the image photographing device 200 may compress a voice converted to the digital signal and provide the compressed voice to the terminal device 100. When a voice decibel is higher than a specific decibel (predetermined setting value set by a user) using a voice signal, the terminal device 100 may determine whether an emergency situation related word previously set by the user is detected from a voice and determine a situation of an image frame to an event situation. Such a terminal device 100 will be described in detail hereinafter.

When the emergency situation button is pushed by the user, the image photographing device 200 provides a push signal of the emergency situation button to the terminal device 100. Accordingly, when the terminal device 100 receives a push signal of an emergency situation button from the image photographing device 200, the terminal device 100 may determine a situation of an image frame to an event situation. Such a terminal device 100 will be described in detail hereinafter.

The image photographing device 200 recognizes low intensity of illumination and provides a brightness signal to the terminal device 100. Accordingly, the terminal device 100 may determine whether a situation of an image frame is an event situation (compared with a predetermined reference value) using a brightness signal. In order to photograph in a low illumination intensity environment, in the image photographing device 200, an IR LED (not shown) may be additionally provided. Further, a low illumination intensity reference may be differently set at a daytime and a night time or a low illumination intensity reference may be differently set according to a time zone. Such a terminal device 100 will be described in detail hereinafter.

The terminal device 100 is a terminal of a user, is a device that receives and stores an image frame provided from the image photographing device 200 or that stores an image frame at the cloud server 300 through a communication network, and may be a common mobile terminal, smart phone, notebook computer, and Personal Digital Assistant (PDA) in which a security management application using an image frame is installed and driven.

The terminal device 100 determines a situation of an image frame provided from the image photographing device 200, adjusts the number of frames recorded per unit time, and records and stores an image frame according to the adjusted number of frames recorded per unit time. In this case, the terminal device 100 may store an image frame at an internal memory module to correspond to a recording location (e.g., GPS location information).

In an exemplary embodiment, when an event occurrence condition is not satisfied, the terminal device 100 reduces the number of frames recorded per unit time and records and stores an image frame. For example, when 60 image frames per second are transmitted from the image photographing device 200, if it is determined that a situation of an image frame is a general situation, the terminal device 100 may record and store the image frame with 0.1 image frames per second. The number of image frames per second transmitted from the image photographing device 200 may be variously changed, it may be set to transmit, for example, 30 image frames per second, and the number of image frames recorded and stored in the terminal device 100 may be variously changed to other conditions (e.g., 0.2 frame per second, 1 frame per second) instead of 0.1 image frame per second.

In another exemplary embodiment, when an event occurrence condition is satisfied, the terminal device 100 increases the number of frames recorded per unit time and records and stores an image frame. For example, when 60 image frames per second are transmitted from the image photographing device 200, if the terminal device 100 is in a state of recording and storing with 0.1 image frame per second corresponding to a general situation, when a situation of an image frame is an event situation, the terminal device 100 may increase with 60 image frames per second, which is a photographing setting value of the image photographing device 200 and record and store the image frames.

When describing the image frame recording and storing process from another viewpoint, in the image photographing device 200, 60 image frames per second are transmitted based on a setting value, and when it is determined that a situation of an image frame is a general situation, the terminal device 100 records and stores with 0.1 image frame per second, if it is determined that an event situation has occurred at any time point, it may be understood that the terminal device 100 increases, records, and stores with 60 image frames per second, which is a photographing setting value of the image photographing device 200. As described above, such an image frame setting value may be variously changed in consideration of a content of an event to be a target of record storage and a device specification condition.

In this case, the terminal device 100 may increase the number of frames recorded per unit time in a range that does not exceed the number of frames provided per unit time from the image photographing device 200. For example, when 60 image frames per second are transmitted from the image photographing device 200, the terminal device 100 may increase the number of frames recorded per unit time in a range (e.g., 40 image frames per second) that does not exceed 60 image frames per second.

Hereinafter, a process in which the terminal device 100 determines whether an event occurrence condition is satisfied will be described in detail.

When a present time is a daytime, but brightness received from the image photographing device 200 is predetermined brightness or less, the terminal device 100 may determine that an event occurrence condition is satisfied and increase, record, and store the number of frames recorded per unit time.

Further, when a user location is not a preset location at a preset time, the terminal device 100 may determine that an event occurrence condition is satisfied and increase, record, and store the number of frames recorded per unit time. For example, when a user location is another location instead of a school at 3 PM, the terminal device 100 may determine that an event occurrence condition is satisfied.

Further, when the terminal device 100 is located at a vehicle, if strength of an impact occurring at the outside of the vehicle is specific strength or more or if a motion (e.g., vehicle contact action of an unspecified person) to the vehicle is detected, the terminal device 100 may determine that an event occurrence condition is satisfied and increase, record, and store the number of frames recorded per unit time.

Further, when the terminal device 100 receives a push signal of an emergency situation button from the image photographing device 200, the terminal device 100 may determine that an event occurrence condition is satisfied and increase, record, and store the number of frames recorded per unit time.

Further, when a decibel of a user voice received from the image photographing device 200 or an interlocked microphone (not shown) is a specific decibel or more (predetermined setting value or more in which a user sets), if a preset emergency situation related word is detected from the user voice, the terminal device 100 may determine that an event occurrence condition is satisfied and increase, record, and store the number of frames recorded per unit time. For this reason, in the terminal device 100, a voice recognition module (not shown) may be provided.

For example, when a decibel of a user voice is 100 decibel or more, the terminal device 100 analyze the user voice, if a word “save” is detected from the user voice, the terminal device 100 may determine that an event occurrence condition is satisfied and increase, record, and store the number of frames recorded per unit time.

Further, if a user location does not exist within a specific radius based on a preset location, the terminal device 100 may determine that an event occurrence condition is satisfied and increase, record, and store the number of frames recorded per unit time. For example, if a location of a student does not exist within a radius 500 m based on a school location, the terminal device 100 may increase, record, and store the number of frames recorded per unit time.

The terminal device 100 stores an image frame at the cloud server 300 through a communication network (e.g., 3G, WiFi, LTE) according to a preset frame transmitting condition. Here, a preset frame transmitting condition is the number of frames transmitted to the cloud server 300 per unit time and may be changed through an application installed in the terminal device 100 according to a kind of a communication network.

When it is determined that a situation of an image frame is an event situation, the terminal device 100 automatically notifies the emergency center terminal 400 that an emergency situation has occurred or automatically notifies a terminal (not shown) of another user related to a user that an emergency situation has occurred. Here, the emergency center terminal 400 may be a terminal located at a fire station and a police station.

The information viewing terminal 500 is a terminal that connects to the cloud server 300 to view an image frame, voice information, and location information.

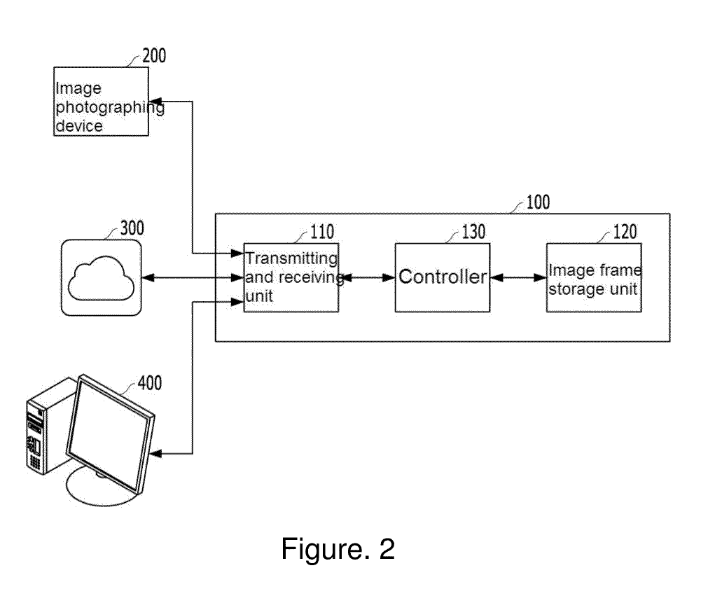

FIG. 2 is a block diagram illustrating an internal configuration of a terminal device according to an exemplary embodiment of the present invention.

Referring to FIG. 2, the terminal device 100 includes a transmitting and receiving unit 110, an image frame storage unit 120, and a controller 130.

The transmitting and receiving unit 110 receives data generated according to a preset frame generation condition from the image photographing device 200. The transmitting and receiving unit 110 provides the received data to the controller 130. Here, data may include an image frame, a voice signal, a push signal of an emergency situation button, and a brightness signal.

In an exemplary embodiment, when the image photographing device 200 and the terminal device 100 are connected through wire communication (e.g., Universal Serial Bus (USB)), the transmitting and receiving unit 110 may receive data through wire communication.

In another exemplary embodiment, when the image photographing device 200 and the terminal device 100 are connected through wireless communication (e.g., Bluetooth), the transmitting and receiving unit 110 may receive data through wireless communication.

The transmitting and receiving unit 110 provides an image frame to a cloud server according to the control of the controller 130.

At the image frame storage unit 120, an image frame is stored according to the control of the controller 130.

In an exemplary embodiment, in the image frame storage unit 120, an image frame may be stored to correspond to a record location (location coordinate information) according to the control of the controller 130. In this case, a voice file corresponding to an image frame may be together stored.

When the controller 130 receives an image frame from the transmitting and receiving unit 110, the controller 130 determines whether a situation of the image frame is a general situation or an event situation.

In an exemplary embodiment, when a situation of an image frame does not satisfy an event occurrence condition, the controller 130 may determine a situation of the image frame to a general situation.

In another exemplary embodiment, when a situation of an image frame satisfies an event occurrence condition, the controller 130 may determine a situation of the image frame to an event situation. Hereinafter, a process in which the controller 130 determines a situation of an image frame to an event situation will be described in detail.

When a present time is a daytime, but brightness received from the transmitting and receiving unit 110 is predetermined brightness or less, the controller 130 may determine that an event occurrence condition is satisfied.

Further, if a user location is not a preset location at a preset time, the controller 130 may determine that an event occurrence condition is satisfied.

Further, when the controller 130 is located at a vehicle, if strength of an impact occurring at the outside of the vehicle is specific strength or more or if a motion to the vehicle is detected, the controller 130 may determine that an event occurrence condition is satisfied and increase, record, and store the number of frames recorded per unit time. A motion to a vehicle may be detected by determining whether, for example, an input image is an image corresponding to a preset specific motion through a known image recognition process.

Further, when the controller 130 receives a push signal of an emergency situation button from the transmitting and receiving unit 110, the controller 130 may determine that an event occurrence condition is satisfied and increase, record, and store the number of frames recorded per unit time.

Further, when a decibel of a user voice received from the transmitting and receiving unit 110 is a specific decibel or more, if an emergency situation related word is detected from the user voice, the controller 130 may determine that an event occurrence condition is satisfied and increase, record, and store the number of frames recorded per unit time.

Further, when a user location does not exist within a specific radius based on a preset location, the controller 130 may determine that an event occurrence condition is satisfied and increase, record, and store the number of frames recorded per unit time.

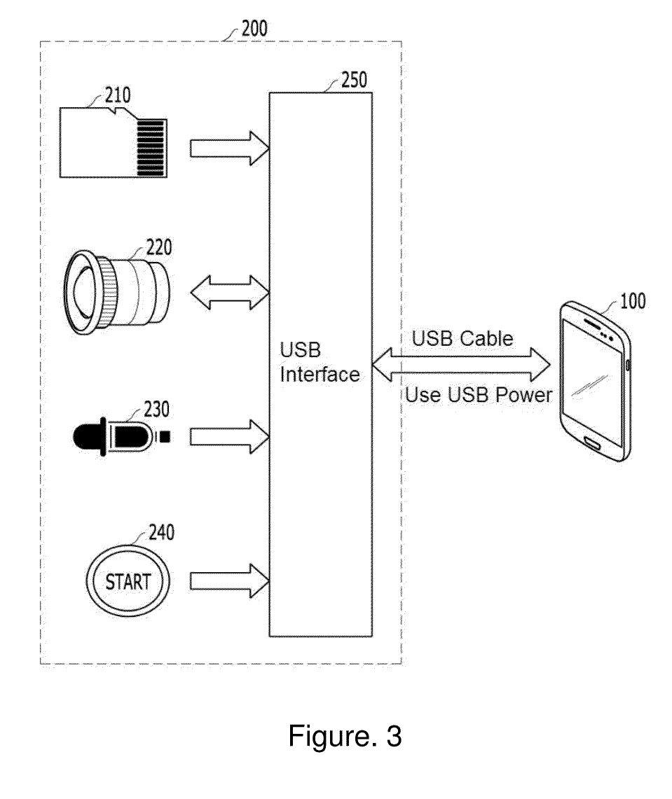

FIG. 3 is a block diagram illustrating an internal configuration of an image photographing device according to an exemplary embodiment of the present invention. An exemplary embodiment of FIG. 3 is an exemplary embodiment in which the image photographing device 200 and the terminal device 100 are connected through wire communication (e.g., Universal Serial Bus (USB) and in which the image photographing device 200 may provide an image frame generated according to a preset frame generation condition to the terminal device 100 with wire communication.

Referring to FIG. 3, the image photographing device 200 includes a memory module 210, a camera module 220, a microphone module 230, an emergency situation button 240, and a USB interface 250.

In the memory module 210, an image frame generated according to a preset frame generation condition is stored. The memory module 210 may be regarded as a selective element and may be provided only in the above-described terminal device 100 and may not be separately provided in the image photographing device 200.

The camera module 220 generates an image frame according to a preset frame generation condition and provides the image frame in the terminal device 100 through the USB interface 250. Here, a preset frame generation condition indicates the number of image frames generated per unit time in the image photographing device 200 and may be connected to a PC or an application installed in the terminal device 100 to be changed.

The microphone module 230 receives an input of a user voice signal, converts the user voice signal to a digital signal, and provides the signal to the terminal device 100 through the USB interface 250.

The emergency situation button 240 is a button pressed by the user in an emergency situation, and when the emergency situation button 240 is pushed by the user, a push signal of the emergency situation button is provided to the terminal device 100 through the USB interface 250.

The USB interface 250 is connected to the terminal device 100 through a USB cable and provides an image frame generated by the camera module 220, a voice signal generated by the microphone module 230, and a push signal of the emergency situation button 240 to the terminal device 100 through USB communication.

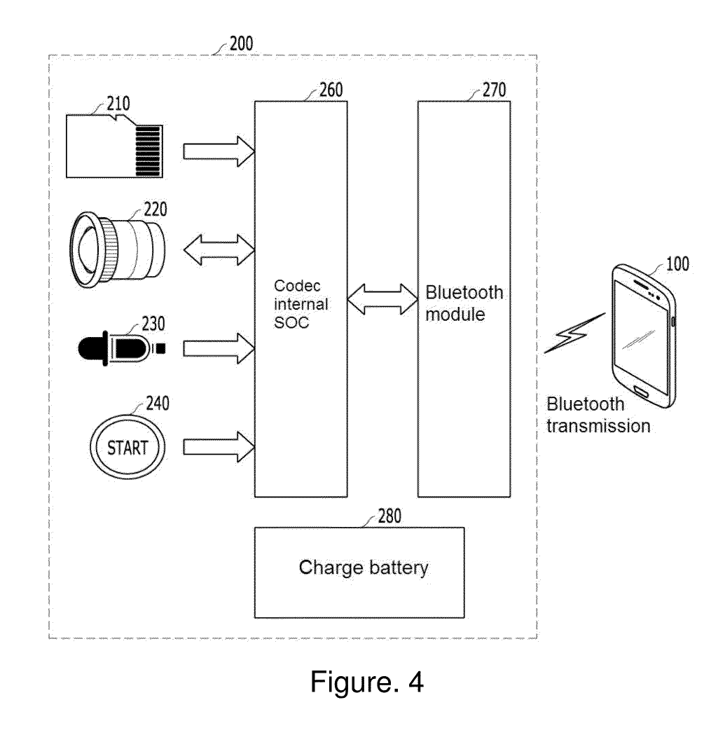

FIG. 4 is a block diagram illustrating an internal configuration of an image photographing device according to another exemplary embodiment of the present invention. An exemplary embodiment of FIG. 4 is an exemplary embodiment in which the image photographing device 200 and the terminal device 100 are connected through wireless communication (e.g., Bluetooth) and in which the image photographing device 200 may provide an image frame generated according to a preset frame generation condition to the terminal device 100 with wireless communication. The wireless communication includes Bluetooth and may include entire known short range wireless communication that can perform image/voice data transmission and reception.

Referring to FIG. 4, the image photographing device 200 may include a memory module 210, a camera module 220, a microphone module 230, an emergency situation button 240, a codec 260, a Bluetooth module 270, and a charge battery 280. The charge battery 230 may be installed at the inside with a method of direct power source connection charge or replacement after charge and may be connected to a known portable type sun light charger for continuous use to be charged.

In the memory module 210, an image frame generated according to a preset frame generation condition may be stored.

The camera module 220 generates an image frame according to a preset frame generation condition, and the image frame is compressed through the codec 260 and is provided to the terminal device 100 through the Bluetooth module 270. Here, a preset frame generation condition indicates the number of image frames generated per unit time in the image photographing device 200 and may be connected to a PC or an application installed in the terminal device 100 to be changed.

The microphone module 230 receives an input of a user voice to convert a user voice signal to a digital signal, and the converted voice signal is compressed through the codec 260 and is provided to the terminal device 100 through the Bluetooth module 270.

The emergency situation button 240 is a button pressed in an emergency situation by the user, and when the emergency situation button 240 is pushed by the user, a push signal of the emergency situation button is provided to the terminal device 100 through the Bluetooth module 270.

The Bluetooth module 270 is connected to the terminal device 100 through Bluetooth communication and provides an image frame generated by the camera module 220, a voice signal generated by the microphone module 230, and a push signal of the emergency situation button 240 to the terminal device 100 through Bluetooth communication.

The codec 260 compresses an image frame generated by the camera module 220 and a voice signal generated by the microphone module 230 and provides the compressed image frame and voice signal to the Bluetooth module 270.

The Bluetooth module 270 provides data compressed in the codec 260 to the terminal device 100 through Bluetooth communication.

The charge battery 280 supplies power to the image photographing device 200.

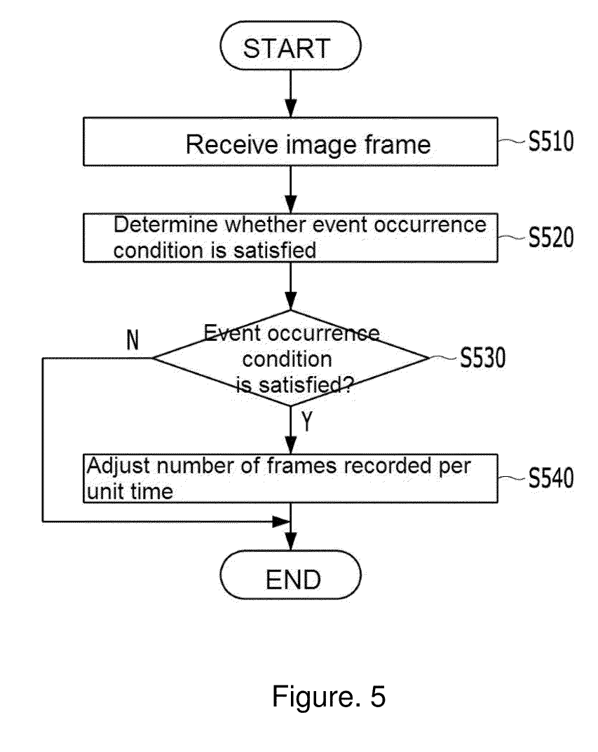

FIG. 5 is a flowchart illustrating a security method using an image frame according to an exemplary embodiment of the present invention.

Referring to FIG. 5, the terminal device 100 receives an image frame generated according to a preset frame generation condition from an image photographing device (step S510).

The terminal device 100 determines whether an event occurrence condition is satisfied (step S520). Here, an event occurrence condition may include at least one of a situation in which a present time is a daytime, but in which brightness received from the image photographing device is predetermined brightness or less, a situation in which a user location is not a preset location at a preset time, a situation in which strength of an impact occurring at the outside of a vehicle is specific strength or more, a situation that detects a motion of a vehicle, a situation that receives a push signal of an emergency situation button from an image photographing device, a situation in which an emergency situation related word is detected from a user voice, when a decibel of the user voice received from an image photographing device or an interlocked microphone is a specific decibel or more, and a situation in which a user location does not exist within a specific radius based on a preset location.

If an event occurrence condition is satisfied, the terminal device 100 adjusts the number of frames recorded per unit time (step S530). That is, if an event occurrence condition is satisfied, the terminal device 100 increases the number of frames recorded per unit time and records and stores an image frame.

The terminal device 100 records and stores an image frame according to the adjusted number of frames recorded per unit time (step S540).

As another example of subordinate step of step S530, when the event occurrence condition is satisfied, the terminal device 100 may increase the number of frames recorded per unit time and record and store the image frame, and if a preset predetermined time has elapsed, the terminal device 100 may record and store an image frame by reducing again the number of frames recorded per unit time to be the same number as that of a case in which an event occurrence condition is not satisfied.

As another example of subordinate step of step S530, the method may further include step of coupling an image frame recorded and stored for a predetermined setting time before a time point in which the event occurrence condition is satisfied and an image frame recorded and stored from a time point in which the event occurrence condition is satisfied to a time point in which a preset predetermined time has elapsed and generating an event image file on a corresponding event.

For example, an image frame recorded and stored for a predetermined setting time (e.g., 30 seconds) before a time point in which the event occurrence condition is satisfied may be an image frame recorded and stored with 0.1 image frame per second, and an image frame recorded and stored from a time point in which the event occurrence condition is satisfied to a time point (e.g., 3 minutes) in which a preset predetermined time has elapsed may be an image frame recorded and stored with 60 image frames per second.

Such a configuration may be understood as follows. For example, the terminal device 100 continuously records and stores an image frame received from the image photographing device 200 and generates a basic image file, and separately from a basic image file recorded and stored according to flow of a time in this way, as in the modified example, only for a predetermined setting time before and after a time point in which an event occurrence condition is satisfied, the terminal device 100 may generate and store a separate event image file.

In this way, in order for a user to determine an image frame in an event situation, with only selecting and reproducing a corresponding event image file without necessary to scan a basic image file from the start to the end, there is a merit that the user can determine an image frame in an event situation.

In such a process, the terminal device 100 may together store a generation time point and location information of an event image file in a meta data form as corresponding file information and provide convenience of event image file reproduction.

Further, the terminal device 100 may transmit and store a basic image file to the cloud server 300, and the terminal device 100 may separately transmit and store an event image file corresponding to each event to the cloud server 300.

Although exemplary embodiments of the present invention have been shown and described, it will be apparent to those having ordinary skill in the art that a number of changes, modifications, or alterations to the invention as described herein may be made, none of which depart from the spirit of the present invention. Therefore, the scope of the present invention is not limited to the described exemplary embodiment but should be determined by the appended claims and their equivalents.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

100: terminal device
110: transmitting and receiving unit
120: image frame storage unit
130: controller
200: image photographing device
210: memory module
220: camera module
230: microphone module
240: emergency situation button
250: USB interface
260: codec
270: Bluetooth module
280: charge battery
300: cloud server
400: emergency center terminal
500: information viewing terminal

What is claimed is:

1. A security method using an image frame executed in a terminal device connected to an image photographing device through wireless communication and interlocked with a cloud server through a communication network, wherein the image photographing device is produced in a brooch or accessory form, and the terminal device is a mobile terminal in which a security management application using an image frame is installed and driven,
receiving an image frame generated according to a preset frame generation condition from the image photographing device;
determining whether an event occurrence condition is satisfied,
wherein the determination comprises:
determination that the event occurrence condition is satisfied in at least one of a situation in which a present time is a daytime, but in which brightness received from the image photographing device is predetermined brightness or less and a situation in which a user location is not a preset location at a preset time, or determination that the event occurrence condition is satisfied in at least one of a situation of receiving a push signal of an emergency situation button from the image photographing device, a situation in which an emergency situation related word is detected from a user voice when a decibel of the user voice received from the image photographing device or an interlocked microphone is a specific decibel or more, and a situation in which the user location does not exist within a specific radius based on a preset location; and
recording and storing, if the event occurrence condition is satisfied, the image frame by increasing the number of frames recorded per unit time, and recording and storing, if a preset predetermined time has elapsed, an image frame by reducing again the number of frames recorded per unit time to be the same number as that of a case in which an event occurrence condition is not satisfied;
generating an event image file on a corresponding event by coupling an image frame recorded and stored for a predetermined setting time before a time point in which the event occurrence condition is satisfied and an image frame recorded and stored from a time point in which the event occurrence condition is satisfied to a time point in which a preset predetermined time has elapsed; and
storing the event image file at a cloud server through a communication network.

2. The security method of claim 1, wherein the recording and storing of the image frame comprises storing the image frame at an internal memory module to correspond to a record location.

3. The security method of claim 1, wherein the preset frame generation condition is connected to a personal computer (PC) or an application installed in the terminal device to be changed.

4. A terminal device connected to an image photographing device through wireless communication and interlocked with a cloud server through a communication network, wherein the image photographing device is produced in a brooch or accessory form, and the terminal device is a mobile terminal in which a security management application using an image frame is installed and driven, the terminal device comprises:
a transmitting and receiving unit that receives an image frame generated according to a preset frame generation condition from the image photographing device;
an image frame storage unit that stores the image frame; and
a controller that determines whether an event occurrence condition is satisfied and that controls to adjust the number of frames recorded per unit time according to a determination result and to record the image frame according to the number of frames recorded per unit time and to store the image frame at the image frame storage unit,
determination whether the event occurrence condition is satisfied comprises:
determination that the event occurrence condition is satisfied in at least one of a situation in which a present time is a daytime, but in which brightness received from the image photographing device is predetermined brightness or less and a situation in which a user location is not a preset location at a preset time, or
determination that the event occurrence condition is satisfied in at least one of a situation that receives a push signal of an emergency situation button from the image photographing device, a situation in which an emergency situation related word is detected from a user voice when a decibel of the user voice received from the image photographing device or an interlocked microphone is a specific decibel or more, and a situation in which the user location does not exist within a specific radius based on a preset location,
wherein the controller increases, if the event occurrence condition is satisfied, the number of frames recorded per unit time and records and stores the image frame, reduces again, if a preset predetermined time has elapsed, the number of frames recorded per unit time to be the same number as that of a case in which an event occurrence condition does not satisfy and records and stores an image frame,
coupling an image frame recorded and stored for a predetermined setting time before a time point in which the event occurrence condition is satisfied and an image frame recorded and stored from a time point in which the event occurrence condition is satisfied to a time point in which a preset predetermined time has elapsed and generating an event image file on a corresponding event, and
controlling to store the event image file at a cloud server through a communication network.

5. A recording medium that stores a program for executing a security method using an image frame executed in a terminal device connected to an image photographing device through wireless communication and interlocked with a cloud server through a communication network, wherein the image photographing device is produced in a brooch or accessory form, and the terminal device is a mobile terminal in which a security management application using an image frame is installed and driven, the recording medium comprising:
a function of receiving an image frame generated according to a preset frame generation condition from the image photographing device;
a function of determining whether an event occurrence condition is satisfied, wherein the determination comprises:
determination that the event occurrence condition is satisfied in at least one of a situation in which a present time is a daytime, but in which brightness received from the image photographing device is predetermined brightness ore less and a situation in which a user location is not a preset location at a preset time, or
determination that the event occurrence condition is satisfied in at least one of a situation that receives a push signal of an emergency situation button from the image photographing device, a situation in which an emergency situation related word is detected from a user voice, when a decibel of the user voice received from the image photographing device or an interlocked microphone is a specific decibel or more, and a situation in which the user location does not exist within a specific radius based on a preset location; and
increasing, if the event occurrence condition is satisfied, the number of frames recorded per unit time and recording and storing the image frame, and recording and storing, when a preset predetermined time has elapsed, an image frame by reducing again the number of frames recorded per unit time to be the same number as that of a case in which an event occurrence condition is not satisfied,
coupling an image frame recorded and stored for a predetermined setting time before a time point in which the event occurrence condition is satisfied and an image frame recorded and stored from a time point in which the event occurrence condition is satisfied to a time point in which a preset predetermined time has elapsed and generating an event image file on a corresponding event, and
a function of storing the event image file at a cloud server through a communication network.
